(19) United States
(12) Patent Application Publication
(10) Pub. No.: US 2021/0056844 A1
(43) Pub. Date: Feb. 25, 2021

(54) ELECTRONIC DEVICE FOR VEHICLE AND OPERATING METHOD OF ELECTRONIC DEVICE FOR VEHICLE

(71) Applicant: LG ELECTRONICS INC., Seoul (KR)

(72) Inventor: Yongsoo PARK, Seoul (KR)

(73) Assignee: LG ELECTRONICS INC., Seoul (KR)

(21) Appl. No.: 16/999,834

(22) Filed: Aug. 21, 2020

(30) Foreign Application Priority Data
Aug. 23, 2019 (KR) PCT/KR2019/010733

(51) Int. Cl. G08G 1/0967; H04W 4/44; G08G 1/16; H04L 12/813; H04L 12/853; H04L 29/06

(52) U.S. Cl. CPC G08G 1/09675; H04W 4/44; G08G 1/166; H04L 63/0254; G08G 1/162; H04L 47/20; H04L 47/2416; G08G 1/165

(57) ABSTRACT

The present disclosure relates to an electronic device for a vehicle including: a processor for specifying an object outside the vehicle based on a received V2X message, determining whether or not the specified object is detected by at least one sensor included in the vehicle, upon determining a current state to be a V2X message processing bottleneck situation, and excluding the V2X message matched with the object from application processing, upon determining that the specified object is detected by the at least one sensor. At least one of an autonomous vehicle, a user terminal or a server of the present disclosure can be linked to an artificial intelligence module, a drone (unmanned aerial vehicle (UAV), a robot, an augmented reality (AR) device, a virtual reality (VR) device, and devices associated with 5G services, etc.

### TECHNICAL FIELD

The present disclosure relates to an electronic device for vehicles and an operating method of the electronic device for vehicles.

### BACKGROUND ART

A vehicle is an apparatus movable in a desired direction by a user seated therein. A representative example of such a vehicle is an automobile. An autonomous vehicle means a vehicle which can automatically travel without manipulation of a person. The autonomous vehicle performs exchange of data through vehicle-to-everything (V2X) communication.

Meanwhile, a hardware security module (HSM) of V2X consumes a large amount of processing power for decoding codes when there are a number of received messages. As such, there is a problem in that it is impossible to process, within an appropriate time, a message to form the basis of recognition of a dangerous situation in an area where a lot of vehicles travel.

In order to solve such a problem, EP02730076B1 proposes a system in which a header region not to be encoded is additionally generated in a message and, as such, a message forming the basis of recognition of a dangerous situation is preferentially processed.

In such a system, however, there is a problem in that a disagreed data area is added and, as such, vehicles implemented in accordance with standards are ignored. For this reason, communication is possible only among vehicles implemented in accordance with the above-mentioned system, and other vehicles cannot process V2X messages received therein.

### DISCLOSURE

### Technical Problem

Therefore, the present disclosure has been made in view of the above problems, and it is an object of the present disclosure to provide an electronic device for a vehicle capable of eliminating a V2X message bottleneck situation.

It is another object of the present disclosure to provide an operating method of an electronic device for a vehicle capable of eliminating a V2X message bottleneck situation.

Objects of the present disclosure are not limited to the above-described objects, and other objects of the present disclosure not yet described will be more clearly understood by those skilled in the art from the following detailed description.

### Technical Solution

In accordance with an aspect of the present disclosure, the above objects can be accomplished by the provision of an electronic device for a vehicle including: a processor for specifying an object outside the vehicle based on a received V2X message, determining whether or not the specified object is detected by at least one sensor included in the vehicle, upon determining a state of a V2X message processing to be a bottleneck situation, and excluding the V2X message matched with the object from application processing, upon determining that the specified object is detected by the at least one sensor.

In accordance with another aspect of the present disclosure, the above objects can be accomplished by the provision of an operating method of an electronic device for a vehicle including the steps of: specifying, by at least one processor, an object outside the vehicle based on a received V2X message; determining, by at least one processor, whether a state of V2X message processing is a bottleneck situation; determining, by at least one processor, whether or not the specified object is detected by at least one sensor included in the vehicle, when the state of a V2X message processing to be the bottleneck situation; and excluding, by at least one processor, the V2X message matched with the object from application processing, when the specified object is determined to be detected by the at least one sensor.

Concrete matters of other embodiments will be apparent from the detailed description and the drawings.

### Advantageous Effects

In accordance with the present disclosure, one or more effects are provided as follows.

When it is impossible to process V2X messages because the amount of the V2X messages is too much, V2X messages associated with objects not recognized by at least one sensor are preferentially processed and, as such, an enhancement in stability is achieved.

The effects of the present disclosure are not limited to the above-described effect and other effects which are not described herein may be derived by those skilled in the art from the description of the claims.

### DESCRIPTION OF DRAWINGS

FIG. 1 is a view illustrating an appearance of a vehicle according to an embodiment of the present disclosure.

FIG. 2 is a control block diagram of a vehicle according to an embodiment of the present disclosure.

FIG. 3 is a control block diagram of an electronic device for a vehicle according to an embodiment of the present disclosure.

FIG. 4 is a flowchart of the vehicle electronic device according to an embodiment of the present disclosure.

FIGS. 5 and 6 are views referred to for explanation of operation of the vehicle electronic device according to an embodiment of the present disclosure.

FIG. 7 illustrates an example of basic operations of an autonomous vehicle and a 5G network in a 5G communication system.

FIG. 8 illustrates an example of application operations of the autonomous vehicle and the 5G network in the 5G communication system.

FIGS. 9 to 12 illustrate an example of operation of the autonomous vehicle using 5G communication.

### BEST MODE

Reference will now be made in detail to the exemplary embodiments of the present disclosure, examples of which are illustrated in the accompanying drawings. Identical or similar constituent elements will be designated by the same reference numeral even though they are depicted in different drawings. The suffixes “module” and “unit” of elements herein are used for convenience of description and thus can be used interchangeably, and do not have any distinguishable meanings or functions. In the following description of the at least one embodiment, a detailed description of known functions and configurations incorporated herein will be omitted for the purpose of clarity and for brevity. The features of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in the present disclosure.

It will be understood that, although the terms “first”, “second”, etc. may be used herein to describe various elements, these elements should not be limited by these terms. These terms are only used to distinguish one element from another element.

It will be understood that, when an element is referred to as being “connected to” or “coupled to” another element, it may be directly connected or coupled to the other element, or intervening elements may be present. In contrast, when an element is referred to as being “directly connected to” or “directly coupled to” another element or layer, there are no intervening elements present.

The singular expressions in the present specification include the plural expressions unless clearly specified otherwise in context.

It will be further understood that the terms “comprises” or “comprising” when used in this specification specify the presence of stated features, integers, steps, operations, elements, or components, but do not preclude the presence or addition of one or more other features, integers, steps, operations, elements, components, or combinations thereof.

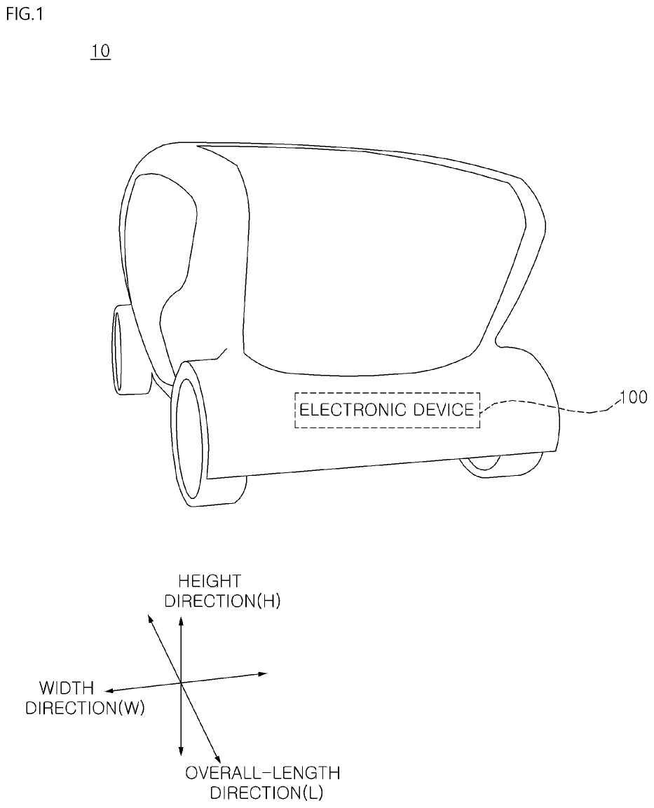

FIG. 1 is a view illustrating an appearance of a vehicle according to an embodiment of the present disclosure.

Referring to FIG. 1, the vehicle 10 according to the embodiment of the present disclosure is defined as a transportation means to travel on a road or a railway line. The vehicle 10 is a concept including an automobile, a train, and a motorcycle. The vehicle 10 may be a concept including all of an internal combustion engine vehicle including an engine as a power source, a hybrid vehicle including an engine and an electric motor as a power source, an electric vehicle including an electric motor as a power source, etc. The vehicle 10 may be a shared vehicle. The vehicle 10 may be an autonomous vehicle.

An electric device 100 may be included in the vehicle 10.

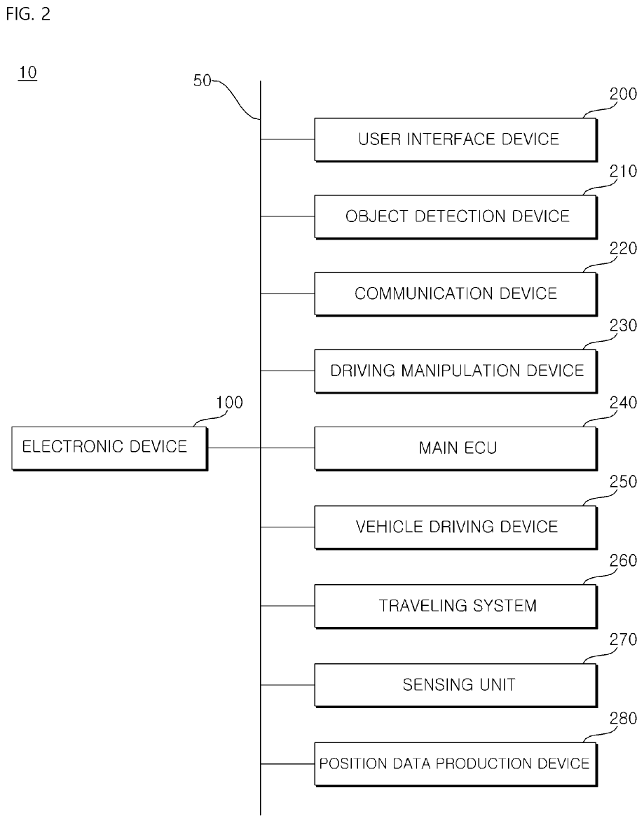

FIG. 2 is a control block diagram of the vehicle according to an embodiment of the present disclosure.

Referring to FIG. 2, the vehicle 10 may include the electronic device 100, a user interface device 200, an object detection device 210, a communication device 220, a driving manipulation device 230, a main electronic control unit (ECU) 240, a vehicle driving device 250, a traveling system 260, a sensing unit 270, and a position data production device 280.

The vehicle electronic device 100 may discriminate a vehicle-to-everything (V2X) message and, as such, may preferentially process a V2X message as to an object that is dangerous to safety of the vehicle 10.

When a number of V2X messages is received, a part in which a bottleneck phenomenon occurs is recognized to be a hardware security module (HSM) to process encoded packets. When a bottleneck phenomenon occurs, there is a problem in that it is difficult to recognize a surrounding vehicle through a V2X message because the electronic device, which processes the V2X message, should process all messages having no concern with safety.

Information previously standardized by information recognizable before occurrence of a bottleneck situation in processing of a V2X message has a source identification (ID) which is maintained for a predetermined time after being generated.

Objects measured by a sensor included in the vehicle may be continuously tracked and, as such, may be recognized to be safe even though the objects are not specified using V2X messages.

The vehicle electronic device 100 may compare the kind and position of an object measured by the sensor included in the vehicle 10 with a message received through V2X, thereby determining whether or not the object is identical to that of the message. The vehicle electronic device 100 adds a VEX message having the ID of the identical object to a filtering list and, as such, may preferentially process a V2X message having a different ID.

Upon receiving a number of V2X messages, the vehicle electronic device 100 may predict a bottleneck situation of reception of the V2X messages. The vehicle electronic device 100 may determine whether or not characteristics of an object of a previously-received V2X message (for example, position range, path, kind, speed, and direction) are identical to characteristics of an object recognized by the sensor included in the vehicle. The vehicle electronic device 100 may discriminate travel of the vehicle and danger level of the object and, as such, may determine a blacklist defined as an exclusion target for application processing of V2X message, and a whitelist defined as an inclusion target for application processing of V2X message.

The vehicle electronic device 100 may ignore or delay-process a message having a V2X source ID corresponding to the blacklist. In addition, the vehicle electronic device 100 may ignore or delay-process a message having a V2X source ID different from that of the blacklist.

The user interface device 200 is a device for enabling communication between the vehicle 10 and the user. The user interface device 200 may receive user input, and may provide information produced in the vehicle 10 to the user. The vehicle 10 may realize user interface (UI) or user experience (UX) through the user interface device 200. The user interface device 200 may be embodied as a display device, a head up display (HUD), a window display device, a cluster device, etc. which are mounted to the vehicle 10. The user interface device 200 may include an input unit, an output unit, and a user monitoring device. The user interface device 200 may include an input device such as a touch input device, a mechanical input device, a voice input device, or a gesture input device. The user interface device 200 may include an output device such as a speaker, a display, or a haptic module. The user interface device 200 may include a user monitoring device such as a driver monitoring system (DMS) or an internal monitoring system (IMS).

The object detection device 210 may detect an object outside the vehicle 10. The object detection device 210 may include at least one sensor capable of detecting an object outside the vehicle 10. The object detection device 210 may include at least one of a camera, a radar, a lidar, an ultrasound sensor or an infrared sensor. The object detection device 210 may provide data as to an object produced based on a sensing signal generated in the sensor to at least one electronic device included in the vehicle.

The camera may produce information as to an object outside the vehicle 10, using an image. The camera may include at least one lens, at least one image sensor, and at least one processor electrically connected to the image sensor, to process a signal received from the image sensor and to produce data as to an object based on the processed signal.

The camera may be at least one of a mono camera, a stereo camera, or an around view monitoring (AVM) camera. Using various image processing algorithms, the camera may acquire position information of an object, information as to a distance from the object or information as to a relative speed with respect to the object. For example, the camera may acquire information as to a distance from an object and information as to a relative speed with respect to the object from an acquired image, based on a variation in the size of the object according to time. For example, the camera may acquire distance information and relative speed information associated with an object through a pin hole model, road surface profiling, etc. For example, the camera may acquire distance information and relative speed information associated with an object from a stereo image acquired by a stereo camera, based on disparity information.

In order to photograph an outside of the vehicle, the camera may be mounted at a position in the vehicle where the camera can secure a field of view (FOV). In order to acquire an image in front of the vehicle, the camera may be disposed in an inner compartment of the vehicle in the vicinity of a front windshield. The camera may be disposed around a front bumper or a radiator grill. In order to acquire an image in rear of the vehicle, the camera may be disposed in the inner compartment of the vehicle in the vicinity of a back glass. The camera may be disposed around a rear bumper, a trunk or a tail gate. In order to acquire an image at a lateral side of the vehicle, the camera may be disposed in the inner compartment of the vehicle in the vicinity of at least one of side windows. Alternatively, the camera may be disposed around a side mirror, a fender, or a door.

The radar may produce information as to an object outside the vehicle 10 using a radio wave. The radar may include an electromagnetic wave transmitter, an electromagnetic wave receiver, and at least one processor electrically connected to the electromagnetic wave transmitter and the electromagnetic wave receiver, to process a received signal and to produce data as to an object based on the processed signal. The radar may be embodied through a pulse radar system or a continuous wave radar system based on a radio wave emission principle. The radar may be embodied through a frequency modulated continuous wave (FMCW) system or a frequency shift keyong (FSK) system selected from continuous wave radar systems in accordance with a signal waveform. The radar may detect an object, a position of the detected object, and a distance and a relative speed with respect to the detected object by means of an electromagnetic wave on the basis of time of flight (TOF) or phase shift. The radar may be disposed at an appropriate position outside the vehicle in order to sense an object disposed at a front, rear or lateral side of the vehicle.

The lidar may produce information as to an object outside the vehicle 10, using laser light. The lidar may include an optical transmitter, an optical receiver, and at least one processor electrically connected to the optical transmitter and the optical receiver, to process a received signal and to produce data as to an object based on the processed signal. The lidar may be embodied through a time-of-flight (TOF) system and a phase shift system. The lidar may be implemented in a driven manner or a non-driven manner. When the lidar is implemented in a driven manner, the lidar may detect an object outside the vehicle 10 while being rotated by a motor. When the lidar is implemented in a non-driven manner, the lidar may detect an object disposed within a predetermined range with reference to the vehicle by optical steering. The vehicle 10 may include a plurality of non-driven lidars. The lidar may detect an object, a position of the detected object, and a distance and a relative speed with respect to the detected object by means of laser light on the basis of time of flight (TOF) or phase shift. The lidar may be disposed at an appropriate position outside the vehicle in order to sense an object disposed at a front, rear or lateral side of the vehicle.

The communication device 220 may exchange signals with a device disposed outside the vehicle 10. The communication device 220 may exchange a signal with at least one of infrastructure (for example, a server or a broadcasting station) or another vehicle. The communication device 220 may include at least one of a transmission antenna, a reception antenna, a radio frequency (RF) circuit or an RF element capable of implementing various communication protocols in order to execute communication.

The communication device 220 may communicate with a device disposed outside the vehicle 10, using a 5G (for example, new radio (NR)) system. The communication device 220 may implement V2X (V2V, V2D, V2P or V2N) communication using the 5G system.

The driving manipulation device 230 is a device for receiving user input for driving. In a manual mode, the vehicle 10 may be driven based on a signal provided by the driving manipulation device 230. The driving manipulation device 230 may include a steering input device (for example, a steering wheel), an acceleration input device (for example, an accelerator pedal), and a brake input device (for example, a brake pedal).

The main ECU 240 may control overall operation of at least one electronic device included in the vehicle 10.

The driving control device 250 is a device for electrically controlling various vehicle driving devices in the vehicle 10. The driving control device 250 may include a powertrain driving control device, a chassis driving control device, a door/window driving control device, a safety device driving control device, a lamp driving control device, and an air conditioner driving control device. The powertrain driving control device may include a power source driving control device and a transmission driving control device. The chassis driving control device may include a steering driving control device, a brake driving control device, and a suspension driving control device.

Meanwhile, the safety device driving control device may include a safety belt driving control device for safety belt control.

The vehicle driving control device 250 may be referred to as a “control electronic control unit (ECU)”.

The traveling system 260 may control motion of the vehicle 10 or may generate a signal for outputting information to the user, based on data as to an object received from the object detection device 210. The traveling system 260 may provide the generated signal to at least one of the user interface device 200, the main ECU 240 or the vehicle driving device 250.

The traveling system 260 may be a concept including an advanced driver-assistance system (ADAS). The ADAS 260 may embody an adaptive cruise control (ACC) system, an autonomous emergency braking (AEB) system, a forward collision warning (FCW) system, a lane keeping assist (LKA) system, a lane change assist (LCA) system, a target following assist (TFA) system, a blind spot detection (BSD) system, an adaptive high beam assist (HBA) system, an auto-parking system (APS), a pedestrian (PD) collision warning system, a traffic sign recognition (TSR) system, a traffic sign assist (TSA) system, a night vision (NV) system, a driver status monitoring (DSM) system, or a traffic jam assist (TJA) system.

The traveling system 260 may include an autonomous electronic control unit (ECU). The autonomous ECU may set an autonomous travel path based on data received from at least one of other electronic devices in the vehicle 10. The autonomous ECU may set an autonomous travel path based on data received from at least one of the user interface device 200, the object detection device 210, the communication device 220, the sensing unit 270, or the position data production device 280. The autonomous traveling ECU may generate a control signal to enable the vehicle 10 to travel along the autonomous travel path. The control signal generated from the autonomous traveling ECU may be provided to at least one of the main ECU 240 or the vehicle driving device 250.

The sensing unit 270 may sense a state of the vehicle. The sensing unit 270 may include at least one of an inertial navigation unit (IMU) sensor, a collision sensor, a wheel sensor, a speed sensor, a slope sensor, a weight sensor, a heading sensor, a position module, a vehicle forward/backward movement sensor, a battery sensor, a fuel sensor, a tire sensor, a handle-rotation-based steering sensor, an internal vehicle temperature sensor, an internal vehicle humidity sensor, an ultrasonic sensor, an ambient light sensor, an accelerator pedal position sensor, or a brake pedal position sensor. Meanwhile, the inertial navigation unit (IMU) sensor may include at least one of an acceleration sensor, a gyro sensor, or a magnetic sensor.

The sensing unit 270 may produce vehicle state data based on a signal generated from at least one sensor. The sensing unit 270 may acquire sensing signals as to vehicle posture information, vehicle motion information, vehicle yaw information, vehicle roll information, vehicle pitch information, vehicle collision information, vehicle direction information, vehicle angle information, vehicle speed information, vehicle acceleration information, vehicle inclination information, vehicle forward/backward movement information, battery information, fuel information, tire information, vehicle lamp information, internal vehicle temperature information, internal vehicle humidity information, a steering wheel rotation angle, ambient illumination outside the vehicle, a pressure applied to the accelerator pedal, a pressure applied to the brake pedal, etc.

In addition, the sensing unit 270 may further include an accelerator pedal sensor, a pressure sensor, an engine speed sensor, an air flow sensor (AFS), an intake air temperature sensor (ATS), a water temperature sensor (WTS), a throttle position sensor (TPS), a top dead center (TDC) sensor, a crank angle sensor (CAS), etc.

The sensing unit 270 may produce vehicle state information based on sensing data. The vehicle state information may be information produced based on data sensed by various sensors included in the vehicle.

For example, the vehicle state information may include vehicle posture information, vehicle speed information, vehicle inclination information, vehicle weight information, vehicle direction information, vehicle battery information, vehicle fuel information, vehicle tire air pressure information, vehicle steering information, internal vehicle temperature information, internal vehicle humidity information, pedal position information, vehicle engine temperature information, etc.

Meanwhile, the sensing unit may include a tension sensor. The tension sensor may generate a sensing signal based on a tension state of a safety belt.

The position data production device 280 may produce position data of the vehicle 10. The position data production device 280 may include at least one of a global positioning system (GPS) or a differential global positioning system (DGPS). The position data production device 280 may produce position data of the vehicle 10 based on a signal generated from at least one of the GPS or the DGPS. In accordance with an embodiment, the position data production device 280 may correct position data based on at least one of an inertial measurement unit (IMU) of the sensing unit 270 or a camera of the object detection device 210.

The position data production device 280 may be referred to as a “position measurement device”. The position data production device 280 may be referred to as a “global navigation satellite system (GNSS)”.

The vehicle 10 may include an inner communication system 50. Plural electronic devices included in the vehicle 10 may exchange a signal via the inner communication system 50. Data may be included in the signal. The inner communication system 50 may utilize at least one communication protocol (for example, CAN, LIN, FlexRay, MOST, or Ethernet).

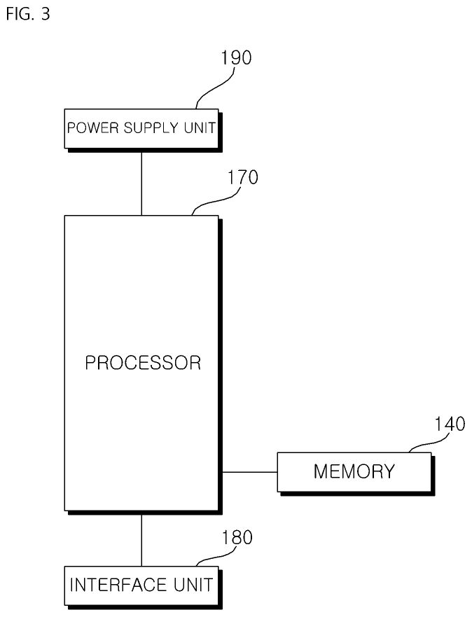

FIG. 3 is a control block diagram of the electronic device according to an embodiment of the present disclosure.

Referring to FIG. 3, the electronic device 100 may include a memory 140, a processor 170, an interface unit 180, and a power supply unit 190.

The memory 140 is electrically connected to the processor 170. The memory 140 may store basic data as to units, control data for unit operation control, and input and output data. The memory 140 may store data processed by the processor 170. The memory 140 may be constituted in a hardware manner by at least one of a read only memory (ROM), a random access memory (RAM), an erasable programmable read-only memory (EPROM), a flash drive, or a hard drive. The memory 140 may store various data for overall operation of the electronic device 100 including a program for processing or controlling the processor 170, etc. The memory 140 may be integrated with the processor 170. In accordance with an embodiment, the memory 140 may be classified into a lower-level configuration of the processor 170.

The interface unit 180 may exchange a signal with at least one electronic device included in the vehicle 10 in a wired or wireless manner. The interface unit 180 may exchange a signal in a wired or wireless manner with at least one of the user interface device 200, the object detection device 210, the communication device 220, the driving manipulation device 230, the main ECU 240, the vehicle driving device 250, the traveling system 260, the sensing unit 270, or the position data production device 280. The interface unit 280 may be constituted by at least one of a communication module, a terminal, a pin, a cable, a port, a circuit, an element, or a device.

The power supply unit 190 may supply electric power to the electronic device 100. The power supply unit 190 may receive electric power from a power source (for example, a battery) included in the vehicle 10 and, as such, may supply electric power to each unit of the electronic device 100. The power supply unit 190 may operate in accordance with a control signal supplied from the main ECU 140. The power supply unit 190 may be embodied using a switched-mode power supply (SMPS).

The processor 170 may be electrically connected to the memory 140, the interface unit 180, and the power supply unit 190, and, as such, may exchange a signal therewith. The processor 170 may be embodied using at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or electrical units for execution of other functions.

The processor 170 may be driven by electric power supplied from the power supply unit 190. In a state in which electric power from the power supply unit 190 is supplied to the processor 170, the processor 170 may receive data, process the data, generate a signal, and supply the signal.

The processor 170 may receive information from other electronic devices in the vehicle 10 via the interface unit 180. The processor 170 may supply a control signal to other electronic devices in the vehicle 10 via the interface unit 180. For example, the interface unit 180 may receive sensing data from the object detection device 210 via the interface unit 180. For example, the processor 170 may receive a V2X message from the communication device 220 via the interface unit 180.

The processor 170 may specify an object outside the vehicle based on a received V2X message. For example, the object outside the vehicle may be another vehicle. For example, the V2X message may include information as to at least one of the size, speed, acceleration, position, path, kind or direction of the object. For example, based on a V2X message, the processor 170 may specify which vehicle of which position is an object matched with the V2X message.

A V2X message may include information as to a subject producing the V2X message. For example, a first V2X message may be produced in a first other vehicle. The processor 170 may match a V2X message with an object based on information as to a V2X message production subject included in the V2X message.

The processor 170 may determine a V2X message processing bottleneck situation. For example, when the number of packets waiting for application processing is not less than a predetermined number, the processor 170 may determine this state to be a V2X message processing bottleneck situation. For example, when the waiting time of packets waiting for application processing is not less than a predetermined time, the processor 170 may determine this state to be a V2X message processing bottleneck situation.

Upon determining the state of a V2X message processing to be the bottleneck situation, the processor 170 may determine whether or not a specified object is detected by at least one sensor included in the vehicle. For example, the processor 170 may determine whether or not a specified first other vehicle is detected by at least one sensor (for example, a camera, a radar, or a lidar) included in the object detection device 200.

Upon determining that a specified object is detected by at least one sensor, the processor 170 may exclude a V2X message matched with the object from application processing.

The processor 170 may selectively generate at least one of a blacklist or a whitelist based on travel situation information of the vehicle. The blacklist may be defined as an exclusion target for application processing of V2X message based on the travel situation information of the vehicle. The blacklist may be arranged through a V2X source identification (ID) list. V2X source IDs may be explained as V2X message production subject IDs. The whitelist may be defined as an inclusion target for application processing of V2X message. The whitelist may be arranged through a V2X source ID list. The V2X source ID may be explained as a V2X message production subject ID.

The travel situation information may include at least one of situation information or traffic information of the current travel road. The situation information of the current travel road may include information as to at least one of a crossroads, a branch point, an accident site or a construction site.

The processor 170 may generate the whitelist when numerical traffic within a predetermined radius around the vehicle 10 is not lower than a reference value. The processor 170 may generate the blacklist when the numerical traffic within the predetermined radius around the vehicle 10 is lower than the reference value.

The processor 170 may generate the blacklist, upon determining that the vehicle 10 is positioned within a predetermined distance from a crossroads.

The processor 170 may generate the whitelist upon determining that the vehicle 10 travels on a road on which there is no crossroads disposed within a predetermined radius.

When a first object specified based on a V2X message is detected by at least one sensor included in the object detection device 200, the processor 170 may add the first object to the blacklist.

When a relative speed value between the first object added to the blacklist and the vehicle 10 is not lower than a reference value, the processor 170 may exclude the first object from the blacklist.

The processor 170 may add, to the whitelist, a second object disposed within a predetermined distance from the vehicle 10.

Upon receiving a first V2X message from a source identification (ID) present in the blacklist, the processor 170 may exclude the first V2X message from application processing.

Upon receiving a second V2X message from a source ID not present in the whitelist, the processor 170 may exclude the second V2X message from application processing.

The processor 170 may update the blacklist or the whitelist at intervals of a predetermined period.

The processor 170 may reduce calculation complexity of V2X. For example, the processor 170 may insert information into a header which is not encoded and, as such, may eliminate a decoding procedure, thereby being capable of reducing calculation complexity.

The processor 170 may sort information received from the object detection device 200 in accordance with characteristics of objects. The processor 170 may sort information received from the communication device 220 in accordance with characteristics of objects. For example, characteristics of an object may include at least one of size, speed, acceleration, position, path, kind, or direction of the object.

The processor 170 may predict a reception bottleneck phenomenon of V2X messages.

The processor 170 may determine whether or not characteristics of an object of a previously-received V2X message are identical to characteristics of an object recognized by the sensor of the object detection device 200.

The processor 170 may determine at least one of a blacklist or a whitelist in accordance with a vehicle travel state (for example, a situation of a road or traffic).

The processor 170 may discriminate danger levels of objects and, as such, may determine priority of messages to which filtering is to be applied.

When the blacklist is determined, the processor 170 may ignore or delay-process all messages having a V2X source ID associated with the blacklist.

When the whitelist is determined, the processor 170 may ignore or delay-process all messages having a V2X source ID associated with the whitelist.

The electronic device 100 may include at least one printed circuit board (PCB). The memory 140, the interface unit 180, the power supply unit 190 and the processor 170 may be electrically connected to the printed circuit board.

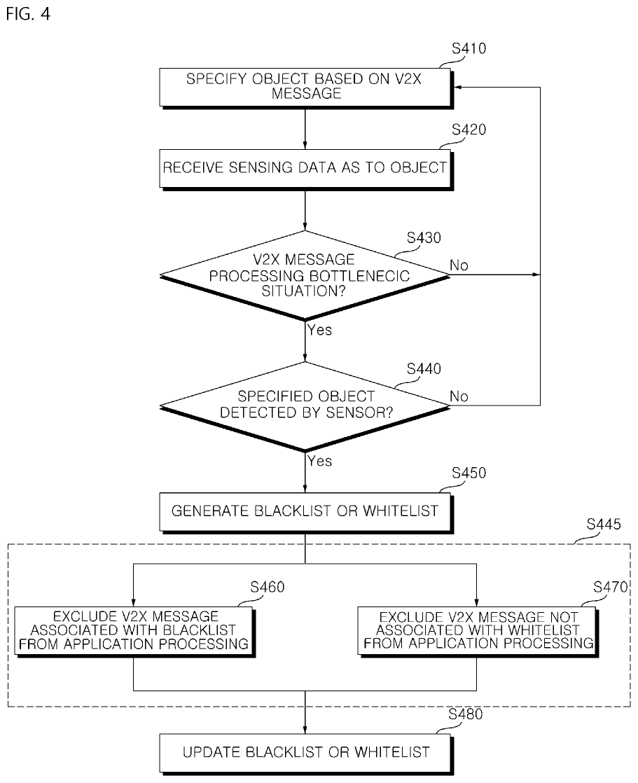

FIG. 4 is a flowchart of the electronic device according to an embodiment of the present disclosure.

Referring to FIG. 4, the processor 170 may specify an object based on a received V2X message (S410). The processor 170 may receive a V2X message from the communication device 220 via the interface unit 180. The processor 170 may specify an object based on the received V2X message.

The processor 170 may receive sensing data as to the object from the object detection device 200 (S420).

The processor 170 may determine a V2X message processing bottleneck situation (S430). The step S430 of determining a V2X message processing bottleneck situation may include a step of determining the state of a V2X message processing to be the bottleneck situation when the number of packets waiting for application processing is not less than a predetermined number. The step S430 of determining a V2X message processing bottleneck situation may include a step of determining the state of a V2X message processing to be the bottleneck situation when the waiting time of packets waiting for application processing is not less than a predetermined time.

Upon determining the state of a V2X message processing to be the bottleneck situation, the processor 170 may determine whether or not the specified object is detected by at least one sensor included in the vehicle 10 (S440).

Upon determining that the specified object is detected by at least one sensor, the processor 170 may exclude a V2X message matched with the object from application processing (S445).

The excluding step S445 may include a step S450 of selectively generating, by at least one processor 170, a blacklist defined as an exclusion target for application processing of V2X message or a whitelist defined as an inclusion target for application processing of V2X message based on a travel situation of the vehicle 10.

The processor 170 may determine at least one of the black and the whitelist in accordance with a vehicle travel state such as a situation of a road and a traffic. The situation of the road may include the kind of the road.

For example, when the vehicle 10 waits for a traffic signal at a crossroads, the vehicle 10 may not receive a V2X message because it may be possible to measure and track front and rear vehicles and lateral vehicles by the sensor. That is, when the vehicle 10 waits for a traffic signal at a crossroads, the processor 170 may generate a blacklist. Of course, when a relative speed difference between a rear vehicle and the subject vehicle is 50 km/h or more, the processor 170 receives a V2X message to acquire information as to the rear vehicle without adding the rear vehicle to the blacklist, even though the rear vehicle can be measured by the sensor.

For example, when the vehicle 10 is in a jammed state on an expressway, the processor 170 may receive V2X messages only from other vehicles around the vehicle 10 including front and rear vehicles and lateral vehicles because the other vehicles are dangerous vehicles. That is, when the vehicle 10 is in a jammed state on an expressway, the processor 170 may generate a whitelist.

In other words, in a V2X message processing bottleneck situation, the processor 170 may determine at least one of a blacklist or a whitelist in accordance with danger levels of objects including other vehicles present around the subject vehicle, taking into consideration a vehicle travel state such as a situation of a road and a traffic.

The generating step S540 may include steps of generating, by at least one processor 170, a whitelist when a numerical traffic within a predetermined radius around the vehicle 10 is not lower than a reference value, and generating, by at least one processor 170, a blacklist when the numerical traffic within the predetermined radius around the vehicle 10 is lower than the reference value.

The generating step S450 may include a step of generating, by at least one processor 170, a blacklist upon determining that the vehicle 10 is positioned within a predetermined distance from a crossroads.

The generating step S450 may include a step of generating, by at least one processor 170, a whitelist upon determining that the vehicle 10 travels on a road on which there is no crossroads disposed within a predetermined radius.

The generating step S450 may include a step of adding, by at least one processor 170, a first object specified based on a V2X message to the blacklist when the first object is detected by the sensor included in the vehicle 10. The generating step S450 may include a step of adding, by at least one processor 170, a second object disposed within a predetermined distance from the vehicle 10 to the whitelist.

Meanwhile, the excluding step S445 may include a step S460 of excluding, by at least one processor 170, a V2X message associated with the blacklist from application processing.

Meanwhile, the excluding step S445 may include a step S470 of excluding, by at least one processor 170, a V2X message not associated with the whitelist from application processing.

Subsequently, the processor 170 may update the blacklist and the whitelist at intervals of a predetermined period (S480).

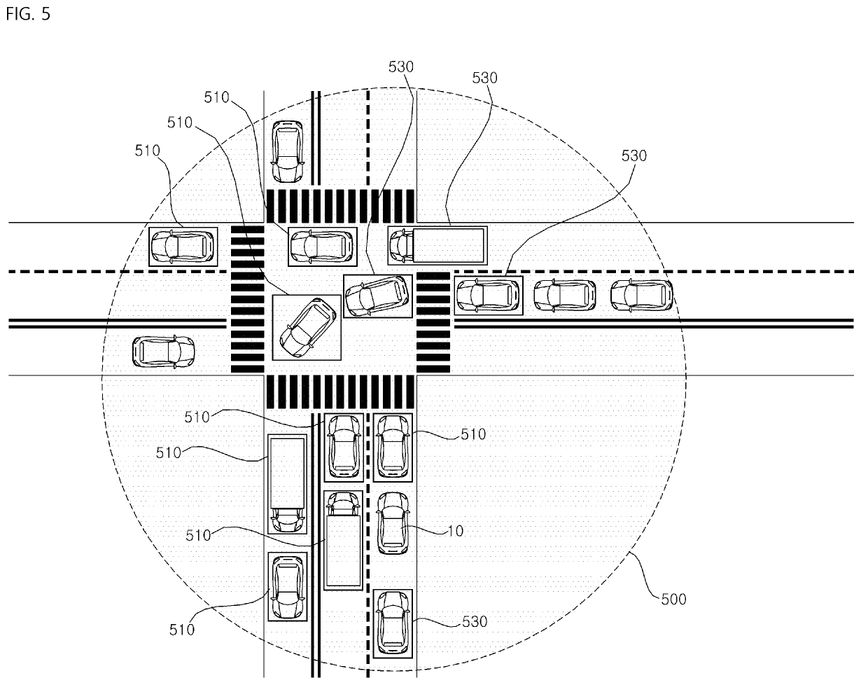

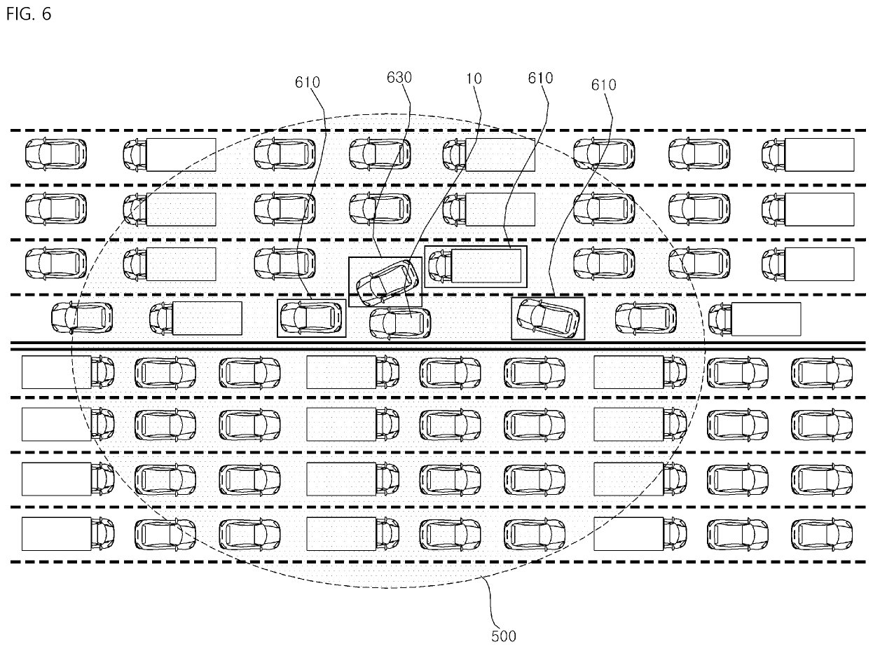

FIGS. 5 and 6 are views referred to for explanation of operation of the vehicle electronic device according to an embodiment of the present disclosure. Meanwhile, operation of the electronic device 100 of FIGS. 5 and 6 is achieved by the processor 170.

Referring to FIG. 5, the vehicle 10 stops around a crossroads. The vehicle 10 stops behind a stop line under the condition that another vehicle 510 is interposed between the stop line and the vehicle 10. Reference numeral “500” designates an area in which the vehicle 10 can receive a V2X message.

Reference numeral “510” designates other vehicles recognized by the vehicle 10 through the object detection device 200 and sorted into a blacklist.

Reference numeral “530” designates other vehicles recognized by the vehicle 10 through the object detection device 200 without being sorted into a blacklist.

The electronic device 100 may predict V2X message reception bottleneck. For example, the electronic device 100 may predict reception bottleneck when the number of packets in an internal reception queue is 5 or more, and a stay time of packets in the internal reception queue is 100 ms or more.

The electronic device 100 may determine whether or not characteristics of an object of a previously-received V2X message are identical to characteristics of an object recognized by the sensor of the object detection device 200. For example, the electronic device 100 may achieve the determination based on at least one of whether or not an object matched with a V2X message and an object recognized by the sensor have a difference of 1 m or less, whether or not the object matched with the V2X message is an object tracked three times or more, whether or not a car size is 10 cm or less, whether or not a speed difference is 3 km/h or less, or whether or not a heading angle is 3° or less. The electronic device 100 may select a blacklist in accordance with a vehicle travel state. For example, the electronic device 100 may select a blacklist based on a situation in which the vehicle 10 waits for start at a crossroads and a situation in which the vehicle is in a stop state in a second row at a crossroads.

The electronic device 100 may discriminate danger levels of objects sensed by the sensor. For example, the electronic device 100 may not receive a V2X message, except for an event message in a stopped state of the vehicle 10. If a relative speed of the vehicle 10 to another vehicle positioned in rear of the vehicle 10 is 50 km/h or more, the other vehicle positioned in a rear side may not be included in the blacklist, even though the other vehicle is a vehicle recognized by the object detection device 200. The electronic device 100 may include, in the blacklist, other vehicles having entrance paths different from an entrance path of the vehicle 10 at a crossroads and, as such, may not receive V2X messages from the other vehicles.

Upon determining the blacklist, the electronic device 100 may store a source ID of a V2X message corresponding to an object recognized by the sensor on a priority queue basis.

When V2X messages enter respective priority queues, the electronic device 100 may identify a source ID of each V2X message to determine whether or not the source ID is identical to a source ID in the blacklist. When the source ID of the V2X message is identical to the source ID in the blacklist, the electronic device 100 may ignore the message.

The electronic device 100 may discard each source ID of the blacklist after a predetermined time (for example, 10 seconds) elapses and, as such, may identify a new danger of the same source ID.

Referring to FIG. 6, the vehicle 10 travels continuously on an expressway having no crossroads and branch point. Reference numeral “500” designates an area in which the vehicle 10 may receive a V2X message.

Reference numeral “610” designates other vehicles recognized by the vehicle 10 through the sensor of the object detection device 200.

Reference numeral “630” designates another vehicle, from which the vehicle 10 receives a V2X message under the condition that the other vehicle is not recognized by the vehicle 10 through the sensor.

The electronic device 100 may predict V2X message reception bottleneck. For example, the electronic device 100 may predict reception bottleneck when the number of packets in an internal reception queue is 5 or more, and a stay time of packets in the internal reception queue is 100 ms or more.

The electronic device 100 may determine whether or not characteristics of an object matched with a previously-received V2X message are identical to characteristics of an object recognized by the sensor of the object detection device 200. For example, the electronic device 100 may achieve the determination based on at least one of whether or not an object matched with a V2X message and an object recognized by the sensor have a difference of 1 m or less, whether or not the object matched with the V2X message is an object tracked three times or more, whether or not a car size is 10 cm or less, whether or not a speed difference is 3 km/h or less, or whether or not a heading angle is 3° or less.

The electronic device 100 may select a whitelist in accordance with a vehicle travel state. For example, the electronic device 100 may select a whitelist based on a situation in which the vehicle 10 travels on an expressway having no crossroads and branch point and a situation in which the vehicle 10 travels at a relative speed of 10 km/h or less to another vehicle in a front side and another vehicle in a rear side.

The electronic device 100 may determine a whitelist based on danger levels of objects sensed by the sensor. Here, danger levels may be determined based on characteristics of objects. For example, the electronic device 100 may sort, into a whitelist, other vehicles traveling at a predetermined relative speed to the vehicle 10 in a state of being spaced apart from the vehicle 10 by a predetermined distance or more.

Since a whitelist is determined, the electronic device 100 may store, in a priority queue, a source ID of a V2X message corresponding to an object sensed by the sensor.

When V2X messages enter respective priority queues, the electronic device 100 may identify a source ID of each V2X message. When the source ID of the V2X message differs from source IDs in the whitelist, the electronic device 100 may ignore the message.

When a new surrounding vehicle recognized by the sensor appears, the electronic device 100 updates each source ID of the whitelist and, as such, may identify a new danger.

The processor 170 may selectively generate at least one of a blacklist and a whitelist based on travel situation information of the vehicle 10.

The processor 170 may receive at least one of a blacklist and a whitelist which are generated by an external server based on travel situation information of the vehicle. The external server may be a server of a 5G communication system.

The external server may selectively generate one of a blacklist defined as an exclusion target for application processing of V2X message and a whitelist defined as an inclusion target for application processing of V2X message, based on a travel situation of the vehicle 10. The external server may generate the blacklist or the whitelist, and may transmit the generated list to the vehicle 10 through 5G communication.

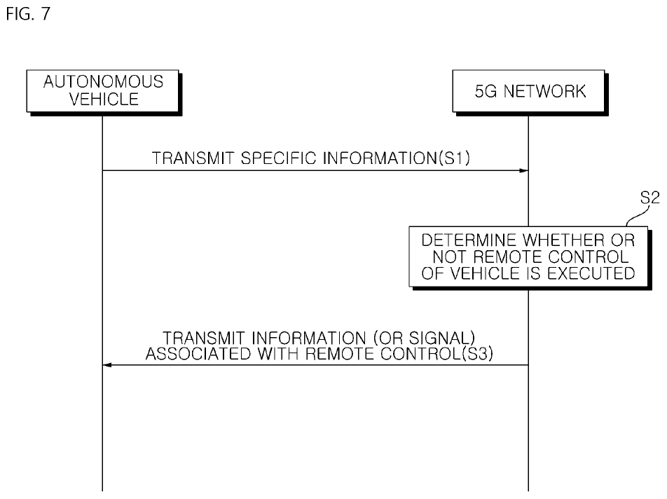

FIG. 7 illustrates an example of basic operations of an autonomous vehicle and a 5G network in a 5G communication system.

The autonomous vehicle 10 transmits specific information to the 5G network (S1).

The specific information may include information associated with autonomous travel.

The autonomous travel-associated information may be information directly associated with control for traveling of the vehicle 10. For example, the autonomous travel-associated information may include at least one of object data indicating an object around the vehicle, map data, vehicle state data, vehicle position data, or driving plan data.

The autonomous travel-associated information may further include service information required for autonomous travel, etc. For example, the service information may include information input through a user terminal as to a destination and a safety grade of the vehicle 10. In addition, the 5G network may determine whether or not remote control of the vehicle 10 is executed (S2).

In this case, the 5G network may include a server or a module for executing remote control associated with autonomous travel.

In addition, the 5G network may transmit information (or a signal) associated with remote control to the autonomous vehicle 10 (S3).

As described above, the information associated with the remote control may be a signal directly applied to the autonomous vehicle 10, and may further include service information required for autonomous travel. In an embodiment of the present disclosure, the autonomous vehicle 10 may provide services associated with autonomous travel by receiving service information such as information as to section-based insurance and a dangerous section selected on a travel path through a server connected to the 5G network.

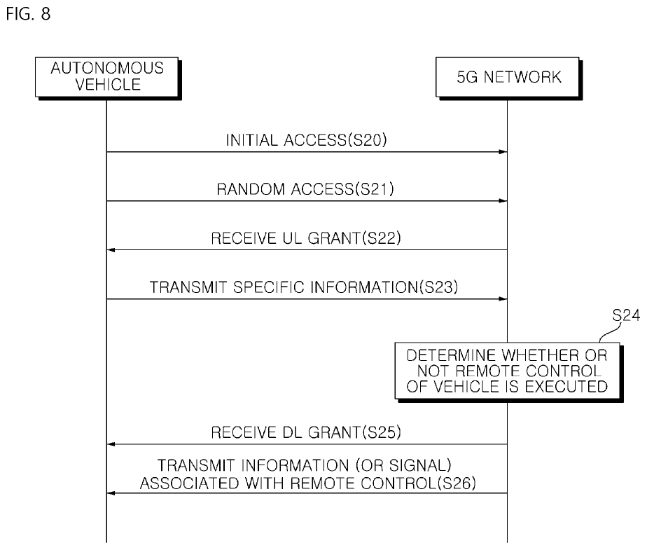

Hereinafter, essential procedures for 5G communication between the autonomous vehicle 10 and the 5G network (for example, a procedure of initial access between the vehicle and the 5G network, etc.) will be briefly described with reference to FIGS. 8 to 12, in order to provide insurance services applicable on a section basis in an autonomous travel procedure in accordance with an embodiment of the present disclosure.

FIG. 8 illustrates an example of application operations of the autonomous vehicle 10 and the 5G network in the 5G communication system.

The autonomous vehicle 10 performs a procedure of initial access to the 5G network (S20).

The initial access procedure includes a cell search procedure for acquiring a downlink (DL) operation, a procedure for acquiring system information, etc.

In addition, the autonomous vehicle 10 performs a procedure of random access to the 5G network (S21).

The random access procedure includes a preamble transmission procedure for uplink (UL) synchronization acquisition or UL data transmission, a random access response reception procedure, etc.

In addition, the 5G network transmits, to the autonomous vehicle 10, a UL grant for scheduling transmission of specific information (S22).

The UL grant reception may include a procedure of receiving time/frequency resource scheduling in order to transmit UL data to the 5G network.

In addition, the autonomous vehicle 10 transmits specific information to the 5G network based on the UL grant (S23).

The 5G network then determines whether or not remote control of the vehicle 10 is executed (S24).

The autonomous vehicle 10 then receives a DL grant through a downlink control channel in order to receive a response to the specific information from the 5G network (S25).

The 5G network then transmits information (or a signal) associated with remote control to the autonomous vehicle 10 based on the DL grant (S26).

Meanwhile, although an example, in which the procedures of initial access and random access of the autonomous vehicle 10 to the 5G communication network and the procedure of receiving a DL grant are combined, has been illustratively described with reference to FIG. 8 through procedures of S20 to S26, the present disclosure is not limited thereto.

For example, the initial access procedure and/or the random access procedure may be executed through steps S20, S22, S23, S24, and S26. In addition, the initial access procedure and/or the random access procedure may be executed through, for example, steps S21, S22, S23, S24, and S26. In addition, a procedure of combining the AI operation and the downlink grant reception procedure may be executed through steps S23, S24, S25, and S26.

In addition, although operation of the autonomous vehicle 10 has been illustratively described with reference to FIG. 8 through steps S20 to S26, the present disclosure is not limited thereto.

For example, operation of the autonomous vehicle 10 may be carried out through selective combination of steps S20, S21, S22, and S25 with steps S23 and S26. In addition, for example, operation of the autonomous vehicle 10 may be constituted by steps S21, S22, S23, and S26. In addition, for example, operation of the autonomous vehicle 10 may be constituted by steps S20, S21, S23, and S26. In addition, for example, operation of the autonomous vehicle 10 may be constituted by steps S22, S23, S25, and S26.

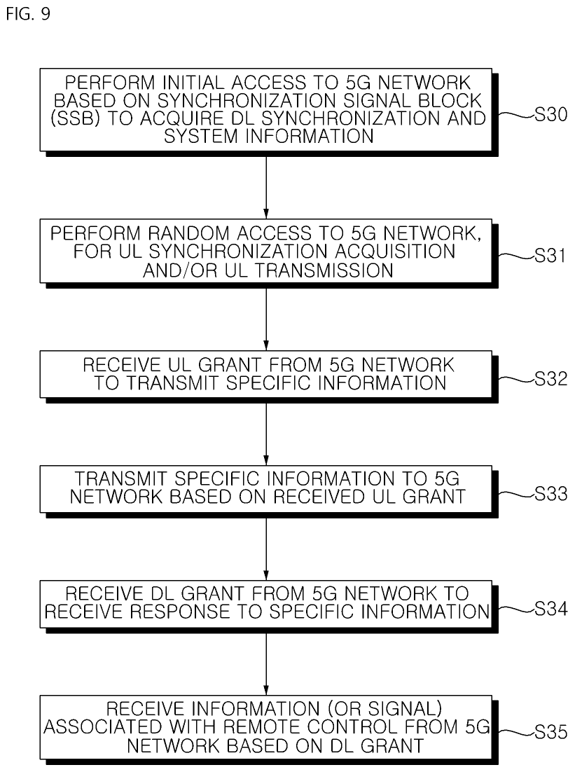

FIGS. 9 to 12 illustrate an example of operation of the autonomous vehicle 109 using 5G communication.

Referring to FIG. 9, the autonomous vehicle 10, which includes an autonomous module, first performs a procedure of initial access to the 5G network based on a synchronization signal block (SSB) in order to acquire DL synchronization and system information (S30).

In addition, the autonomous vehicle 10 performs a procedure of random access to the 5G network, for UL synchronization acquisition and/or UL transmission (S31).

In addition, the autonomous vehicle 10 receives a UL grant from the 5G network in order to transmit specific information (S32).

In addition, the autonomous vehicle 10 transmits the specific information to the 5G network based on the UL grant (S33).

In addition, the autonomous vehicle 10 receives a DL grant from the 5G network in order to receive a response to the specific information (S34).

In addition, the autonomous vehicle 10 receives information (or a signal) associated with remote control from the 5G network based on the DL grant (S35).

A beam management (BM) procedure may be added to step S30. A beam failure recovery procedure associated with transmission of a physical random access channel (PRACH) may be added to step S31. A quasi-co-location (QCL) relation may be added to step S32 in association with a beam reception direction of a physical downlink control channel (PDCCH) including a UL grant. A QCL relation may be added to step S33 in association with a beam transmission direction of a physical uplink control channel (PUCCH)/physical uplink shared channel (PUSCH) including specific information. In addition, a QCL relation may be added to step S34 in association with a beam reception direction of a PDCCH including a DL grant.

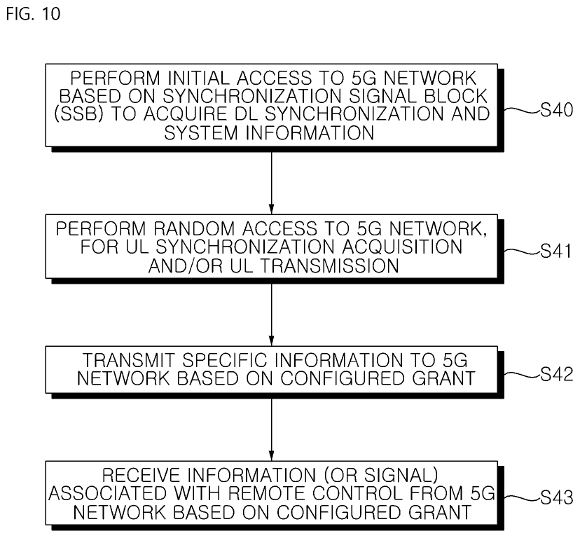

Referring to FIG. 10, the autonomous vehicle 10 performs a procedure of initial access to a 5G network based on an SSB in order to acquire DL synchronization and system information (S40).

In addition, the autonomous vehicle 10 performs a procedure of random access to the 5G network, for UL synchronization acquisition and/or UL transmission (S41).

In addition, the autonomous vehicle 10 transmits specific information to the 5G network based on a configured grant (S42). Transmission of the specific information may be carried out based on the configured grant in place of the procedure of performing reception of a UL grant from the 5G network.

*177In addition, the autonomous vehicle 10 receives information (or a signal) associated with remote control from the 5G network based on the configured grant (S43).

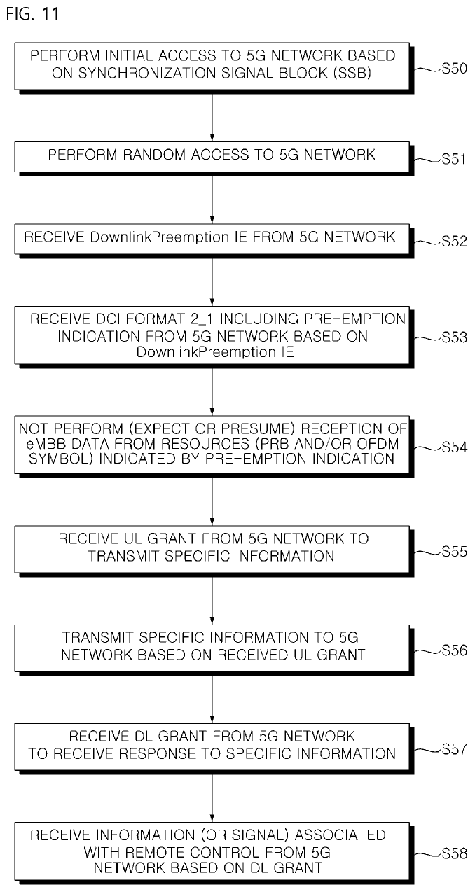

Referring to FIG. 11, the autonomous vehicle 10 performs a procedure of initial access to the 5G network based on an SSB in order to acquire DL synchronization and system information (S50).

In addition, the autonomous vehicle 10 performs a procedure of random access to the 5G network, for UL synchronization acquisition and/or UL transmission (S51).

In addition, the autonomous vehicle 10 may receive a DownlinkPreemption IE from the 5G network (S52).

In addition, the autonomous vehicle 10 receives a downlink control information (DCI) format 2_1 including a preemption indication from the 5G network based on the DownlinkPreemption IE (S53).

In addition, the autonomous vehicle 10 does not perform (expect or presume) reception of enhanced mobile broadband (eMBB) data from resources (physical resource block (PRB) symbols and/or orthogonal frequency division multiplexing (OFDM) symbols) indicated by the pre-emption indication (S54).

In addition, the autonomous vehicle 10 receives a UL grant from the 5G network in order to transmit specific information (S55).

In addition, the autonomous vehicle 10 transmits the specific information to the 5G network based on the UL grant (S56).

In addition, the autonomous vehicle 10 receives a DL grant from the 5G network in order to receive a response to the specific information (S57).

In addition, the autonomous vehicle 10 receives information (or a signal) associated with remote control from the 5G network based on the DL grant (S58).

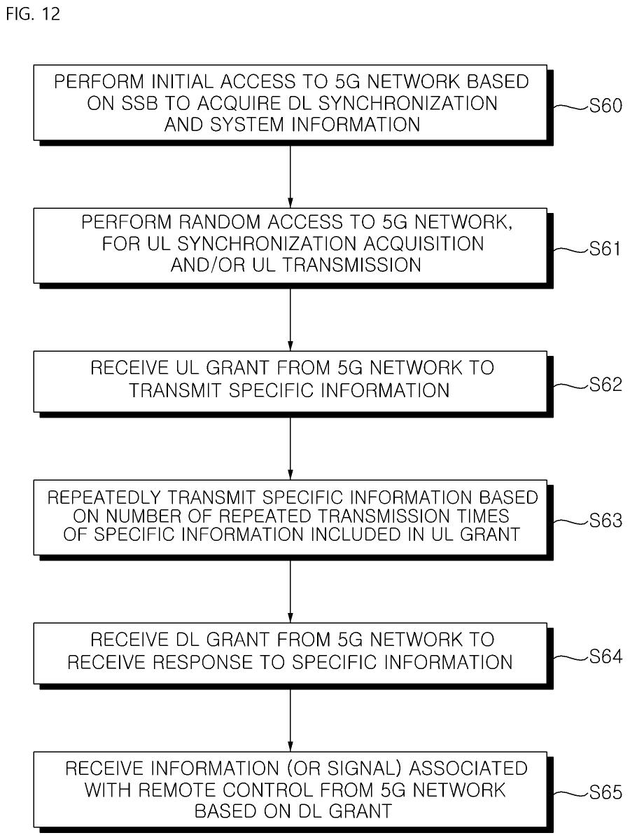

Referring to FIG. 12, the autonomous vehicle 10 performs a procedure of initial access to the 5G network based on an SSB in order to acquire DL synchronization and system information (S60).

In addition, the autonomous vehicle 10 performs a procedure of random access to the 5G network, for UL synchronization acquisition and/or UL transmission (S61).

In addition, the autonomous vehicle 10 receives a UL grant from the 5G network in order to transmit specific information (S62).

The UL grant includes information as to the number of repeated transmission times of the specific information. The specific information is repeatedly transmitted based on the information as to the number of repeated transmission times (S63).

In addition, the autonomous vehicle 10 transmits the specific information to the 5G network based on the UL grant.

Repeated transmission of specific information is carried out through frequency hopping. Transmission of first specific information may be achieved through a first frequency resource, and transmission of second specific information may be achieved through a second frequency resource.

The specific information may be transmitted through a narrow band of 6RB (Resource Block) or 1RB (Resource Block).

In addition, the autonomous vehicle 10 receives a DL grant from the 5G network in order to receive a response to the specific information (S64).

In addition, the autonomous vehicle 10 receives information (or a signal) associated with remote control from the 5G network based on the DL grant (S65).

The above-described 5G communication technology may be applied in a state of being combined with the methods proposed in the present disclosure and described with reference to FIGS. 1 to 6, and may be supplemented to concretize or clarify technical features of the methods proposed in the present disclosure.

The vehicle 10 disclosed in the present disclosure is connected to an external server through a communication network, and is movable along a predetermined path without intervention of a driver using autonomous traveling technology. The vehicle 10 may be embodied using an internal combustion engine vehicle including an engine as a power source, a hybrid vehicle including an engine and an electric motor as a power source, an electric vehicle including an electric motor as a power source, etc.

In the following embodiment, the user may be interpreted as a driver, a passenger, or a possessor of a user terminal. The user terminal may be a mobile terminal portable by the user to execute telephone communication and various applications, for example, a smartphone, without being limited thereto. For example, the user terminal may be interpreted as a mobile terminal, a personal computer (PC), a notebook computer, or an autonomous vehicle system.

In the autonomous vehicle 10, the type and occurrence frequency of accidents may be greatly varied in accordance with ability to sense surrounding dangerous factors in real time. The path to a destination may include sections having different danger levels in accordance with various causes such as weather, features, traffic congestion, etc. In accordance with the present disclosure, insurance needed on a section basis is informed when a destination of the user is input, and insurance information is updated in real time through monitoring of dangerous sections.

At least one of the autonomous vehicle 10 of the present disclosure, a user terminal or a server may be linked to or combined with an artificial intelligence module, a drone (unmanned aerial vehicle (UAV), a robot, an augmented reality (AR) device, devices associated with virtual reality (VR) and 5G services, etc.

For example, the autonomous vehicle 109 may operate in linkage with at least one artificial intelligence module included in the vehicle 10 and a robot.

For example, the vehicle 10 may co-operate with at least one robot. The robot may be an autonomous mobile robot (AMR) which is autonomously movable. The mobile robot is configured to be autonomously movable and, as such, is freely movable. The mobile robot may be provided with a plurality of sensors to enable the mobile robot to bypass an obstacle during travel and, as such, may travel while bypassing obstacles. The mobile robot may be a flying robot (for example, a drone) including a flying device. The mobile robot may be a wheeled robot including at least one wheel, to move through rotation of the wheel. The mobile robot may be a leg type robot including at least one leg, to move using the leg.

The robot may function as an apparatus for supplementing convenience of the user of the vehicle. For example, the robot may perform a function for transporting a load carried in the vehicle 10 to a user's final destination. For example, the robot may perform a function for guiding a way to a final destination to the user having exited the vehicle 10. For example, the robot may perform a function for transporting the user having exited the vehicle 10 to a final destination.

At least one electronic device included in the vehicle may perform communication with the robot through the communication device 220.

At least one electronic device included in the vehicle 10 may provide, to the robot, data processed in at least one electronic device included in the vehicle 10. For example, at least one electronic device included in the vehicle 10 may provide, to the robot, at least one of object data indicating an object around the vehicle 10, map data, state data of the vehicle 10, position data of the vehicle 10 or driving plan data of the vehicle 10.

At least one electronic device included in the vehicle 10 may receive, from the robot, data processed in the robot. At least one electronic device included in the vehicle 10 may receive at least one of sensing data produced in the robot, object data, robot state data, robot position data or robot movement plan data.

At least one electronic device included in the vehicle may generate a control signal further based on data received from the robot. For example, at least one electronic device included in the vehicle 10 may compare information as to an object produced in an object detection device with information as to an object produced by the robot, and may generate a control signal based on compared results. At least one electronic device included in the vehicle 10 may generate a control signal in order to prevent interference between a travel path of the vehicle 10 and a travel path of the robot.

At least one electronic device included in the vehicle may include a software module or a hardware module (hereinafter, an artificial intelligence (AI) module) realizing artificial intelligence. At least one electronic device included in the vehicle 10 may input acquired data to the artificial intelligence module, and may use data output from the artificial intelligence module.

The artificial intelligence module may execute machine learning of input data, using at least one artificial neural network (ANN). The artificial intelligence module may output driving plan data through machine learning of input data.

At least one electronic device included in the vehicle 10 may generate a control signal based on data output from the artificial intelligence module.

In accordance with an embodiment, at least one electronic device included in the vehicle 10 may receive data processed through artificial intelligence from an external device via the communication device 220. At least one electronic device included in the vehicle 10 may generate a control signal based on data processed through artificial intelligence.

The present disclosure as described above may be embodied as computer-readable code, which can be written on a program-stored recording medium. The recording medium that can be read by a computer includes all kinds of recording media on which data that can be read by a computer system is written. Examples of recording media that can be read by a computer may include a hard disk drive (HDD), a solid state drive (SSD), a silicon disk drive (SDD), a read only memory (ROM), a random access memory (RAM), a CD-ROM, a magnetic tape, a floppy disk, an optical data storage, etc., and may include an embodiment having the form of a carrier wave (for example, transmission over the Internet). In addition, the computer may include a processor or a controller. Accordingly, it will be apparent to those skilled in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

1. An electronic device for a vehicle comprising:
a processor configured to:
specify an object outside the vehicle based on a received V2X message,
determine whether the specified object is detected by at least one sensor included in the vehicle, upon determining a state of a V2X message processing to be a bottleneck situation, and
exclude the V2X message matched with the object from a target for application processing, upon determining that the specified object is detected by the at least one sensor.

2. The electronic device for the vehicle according to claim 1, wherein the processor is configured to determine the state of a V2X message processing to be the bottleneck situation when a number of packets waiting for application processing is not less than a predetermined number.

3. The electronic device for the vehicle according to claim 1, wherein the processor is configured to determine the state of a V2X message processing to be the bottleneck situation when a waiting time of packets waiting for application processing is not less than a predetermined time.

4. The electronic device for the vehicle according to claim 1, wherein the processor selectively generates at least one of a blacklist defined as an exclusion target for application processing of V2X message or a whitelist defined as an inclusion target for application processing of V2X message, based on travel situation information of the vehicle.

5. The electronic device for the vehicle according to claim 4, wherein the processor is configured to:
generate the whitelist when numerical traffic within a predetermined radius around the vehicle is not lower than a reference value; and
generate the blacklist when the numerical traffic within the predetermined radius around the vehicle is lower than the reference value.

6. The electronic device for the vehicle according to claim 4, wherein the processor is configured to generate the blacklist, upon determining that the vehicle is positioned within a predetermined distance from a crossroads.

7. The electronic device for the vehicle according to claim 4, wherein the processor is configured to generate the whitelist upon determining that the vehicle travels on a road on which there is no crossroads disposed within a predetermined radius.

8. The electronic device for the vehicle according to claim 4, wherein the processor is configured to, when a first object specified based on a V2X message is detected by the sensor, add the first object to the blacklist.

9. The electronic device for the vehicle according to claim 8, wherein the processor is configured to, when a relative speed value between the first object added to the blacklist and the vehicle is not lower than a reference value, exclude the first object from the blacklist.

10. The electronic device for the vehicle according to claim 4, wherein the processor the processor is configured to add, to the whitelist, a second object disposed within a predetermined distance from the vehicle.

11. The electronic device for the vehicle according to claim 4, wherein the processor is configured to, upon receiving a first V2X message from a source identification (ID) present in the blacklist, exclude the first V2X message from the target for application processing.

12. The electronic device for the vehicle according to claim 4, wherein the processor is configured to, upon receiving a second V2X message from a source identification (ID) not present in the whitelist, exclude the second V2X message from the target for application processing.

13. The electronic device for the vehicle according to claim 4, wherein the processor the processor is configured to update the blacklist or the whitelist at intervals of a predetermined period.

14. An operating method of an electronic device for a vehicle comprising of:
specifying, by at least one processor, an object outside the vehicle based on a received V2X message;
determining, by at least one processor, whether a state of a V2X message processing is a bottleneck situation;
determining, by at least one processor, whether the specified object is detected by at least one sensor included in the vehicle, when a state of a V2X message processing is a bottleneck situation; and
excluding, by at least one processor, the V2X message matched with the object from a target for application processing, when the specified object is determined to be detected by the at least one sensor.

15. The operating method of the electronic device for the vehicle according to claim 14, wherein the excluding comprises selectively generating, by at least one processor, at least one of a blacklist defined as an exclusion target for application processing of V2X message or a whitelist defined as an inclusion target for application processing of V2X message, based on a travel situation of the vehicle.

16. The operating method of the electronic device for the vehicle according to claim 15, wherein the generating comprises of:
generating, by at least one processor, the whitelist when numerical traffic within a predetermined radius around the vehicle is not lower than a reference value; and
generating, by at least one processor, the blacklist when the numerical traffic within the predetermined radius around the vehicle is lower than the reference value.

17. The operating method of the electronic device for the vehicle according to claim 15, wherein the generating comprises of generating, by at least one processor, the blacklist when the vehicle is determined to be positioned within a predetermined distance from a crossroads.

18. The operating method of the electronic device for the vehicle according to claim 15, wherein the generating comprises of generating, by at least one processor, the whitelist when the vehicle is determined to travel on a road on which there is no crossroads disposed within a predetermined radius.

19. The operating method of the electronic device for the vehicle according to claim 15, wherein the generating comprises of adding, by at least one processor, a first object specified based on a V2X message to the blacklist when the first object is detected by the sensor.

20. The operating method of the electronic device for the vehicle according to claim 15, wherein the generating comprises of adding, by at least one processor, a second object disposed within a predetermined distance from the vehicle to the whitelist.
